(19) United States
(12) Patent Application Publication
(10) Pub. No.: US 2012/0185215 A1
(43) Pub. Date: Jul. 19, 2012

(54) RECORDING MEDIUM STORING PROGRAM FOR DETERMINING EFFECTIVE LIGHT SOURCE AND RECORDING MEDIUM STORING PROGRAM FOR DETERMINING INTENSITY TRANSMITTANCE DISTRIBUTION OF FREQUENCY FILTER

(75) Inventor: Manabu Hakko, Utsunomiya-shi (JP)

(73) Assignee: CANON KABUSHIKI KAISHA, Tokyo (JP)

(21) Appl. No.: 13/349,654

(22) Filed: Jan. 13, 2012

(30) Foreign Application Priority Data
Jan. 18, 2011 (JP) 2011-008170

(51) Int. Cl. G06F 15/00; G01J 1/00

(52) U.S. Cl. 702/189

(57) ABSTRACT

A recording medium stores a program for determining an effective light source based on a first function having a linear relationship with light intensities in plural regions on a pupil plane and a second function having a nonlinear relationship with the light intensities. The method comprises: calculating the light intensity on the image plane when a value of a light intensity in one region on the pupil plane is defined as a unit amount and the values of light intensities in all the remaining regions are defined as zero; calculating the values of the first and second functions; setting values of light intensities to a predetermined value when the value of the second function is less than a threshold; and setting value of light intensities in accordance with the value of the first function when the value of the second function is not less than the threshold.

### BACKGROUND OF THE INVENTION

1. Field of the Invention

The present invention relates to a medium storing a program for determining an effective light source and a medium storing a program for determining the intensity transmittance distribution of a frequency filter.

2. Description of the Related Art

As methods of determining data based on a plurality of objective functions, linear programming and a method of improving the solution by repeated computation, for example, have been proposed. In the method of improving the solution by repeated computation, data is determined by performing a large number of trial computations, and selecting an excellent solution. In the linear programming, data is determined by response linearization. Japanese Patent No. 3170828 proposes a method of making the best use of failure information obtained in the course of processes for subsequent processes in determining data based on the plurality of objective functions. This method can set data suitable for conditions to be satisfied by the data in the course of processes.

Japanese Patent Laid-Open No. 2004-247737 discloses a method of determining light source data for exposure, based on a plurality of objective functions. In Japanese Patent Laid-Open No. 2004-247737, individual responses to a plurality of objective functions for each of light source elements divided within the pupil plane of an illumination optical system are calculated to adjust light source data based on the calculation results of the individual responses. Japanese Patent Laid-Open No. 2002-261004 discloses optimization of the pattern of an original and the light source data for exposure in the field of the exposure technology. Japanese patent Laid-Open No. 2002-261004 proposes two-step optimization to select an appropriate one of a plurality of local optimum solutions. In the first optimization operation, a global optimum solution is searched based on a simplified constraint while the degree of local convergence is low. In the second optimization operation, the solution obtained by the first optimization operation is optimized with respect to a criterion closer to a perfect solution using existing local optimization techniques including commercially-available techniques. The method disclosed in Japanese Patent Laid-Open No. 2002-261004 is effective for a problem in which one objective function has a plurality of local optimum solutions. Also, the method described in Japanese Patent Laid-Open No. 2002-261004 is applicable when the object to be evaluated has a plurality of objective functions as well.

The method of improving the solution by repeated computation requires a large number of trial computations, thus prolonging the computation time. The linear programming requires linearly approximating a nonlinear response, thus making it impossible to precisely process the nonlinear response. The method described in Japanese Patent No. 3170828 requires repeating a process associated with a combination satisfaction problem to determine data which satisfies a condition given by the user. Also, the method described in Japanese Patent No. 3170828 determines a discrete value as data but does not determine a continuous quantity. Japanese Patent Laid-Open No. 2004-247737 clearly explains a method of computing individual responses used to determine light source data. However, Japanese Patent Laid-Open No. 2004-247737 gives no clear explanation for a detailed method of adjusting light source data based on a plurality of individual responses, and therefore does not explain how to process the individual responses. A conventional optimization method is applicable to the individual responses obtained in Japanese Patent Laid-Open No. 2004-247737. Accordingly, Japanese Patent Laid-Open No. 2004-247737 presents a proposal associated with a method of computing the individual responses, but proposes neither a novel optimization method nor a novel method of processing the individual responses to adjust the light source. This patent literature encounters a challenge in more effectively determining light source data by, for example, classifying the computed individual responses, and performing processes suitable for the individual responses.

Japanese Patent Laid-Open No. 2002-261004 provides a method of obtaining a better local optimization result by performing two-step optimization including global optimization and local optimization for a problem in which one objective function has a plurality of local optimum solutions. However, in the method described in Japanese Patent Laid-Open No. 2002-261004, the amount of computation for one objective function increases upon two-step optimization. Also, the method described in Japanese Patent Laid-Open No. 2002-261004 requires repeated computation. Moreover, Japanese Patent Laid-Open No. 2002-261004 describes that a plurality of objective functions may be used, but explains a method for only one objective function and therefore gives no detailed description as to how to process a plurality of different objective functions in practice. In general, when the object to be evaluated has objective functions having different numbers of dimensions, it is not physically rational to perform optimization by simply using their linear sum. In addition, when the weight of the linear sum, which reflects the number of dimensions of the objective functions, is optimized, the amount of computation increases in proportion to the problem complexity.

### SUMMARY OF THE INVENTION

The present invention efficiently determines the values of quantities to be determined for a plurality of objective functions.

The present invention in its one aspect provides a recording medium storing a program for causing a computer to execute a method of determining, based on a plurality of objective functions, a light intensity distribution to be formed on a pupil plane of an illumination optical system in an apparatus which forms, on an image plane of a projection optical system, an image of a pattern of an original illuminated with light emitted by the illumination optical system, the plurality of objective functions including a first objective function represented as a function which has a linear relationship with light intensities in a plurality of regions obtained by dividing the pupil plane, and a second objective function represented as a function which has a nonlinear relationship with the light intensities in the plurality of regions on the pupil plane, the method comprising: a first step of calculating, for each region on the pupil plane, the light intensity on the image plane when a value of a light intensity in one region among the plurality of regions on the pupil plane is defined as a unit amount, and the values of light intensities in all the remaining regions are defined as zero; a second step of calculating, for the each region on the pupil plane, the value of the first objective function and the value of the second objective function using the light intensities on the image plane, which are calculated in the first step; a third step of setting values of light intensities in a region, in which the value of the second objective function is less than a threshold, to a predetermined value set in advance regardless of an absolute value of the value of the first objective function; and a fourth step of setting values of light intensities in a region, in which the value of the second objective function is not less than the threshold, in accordance with the value of the first objective function.

Further features of the present invention will become apparent from the following description of exemplary embodiments with reference to the attached drawings.

### BRIEF DESCRIPTION OF THE DRAWINGS

FIG. 1 is a flowchart showing a sequence of determining the values of quantities to be determined;

FIGS. 2A to 2D are views showing a target pattern, evaluation positions, and triangular image intensity approximation according to the first embodiment;

FIGS. 3A to 3F are charts showing light source elements accepted in respective holes according to the first embodiment;

FIGS. 4A to 4G are charts showing adjustment of the intensity values of the light source elements according to the first embodiment;

FIGS. 5A to 5G are views showing the imaging performance according to the first embodiment;

FIGS. 6A and 6B are diagrams showing frequency filters according to the second embodiment;

FIG. 7 is a diagram showing the frequency filter according to the second embodiment;

FIG. 8 is a table showing the response value according to the second embodiment;

FIG. 9 is a table showing the intensity transmittance in each frequency zone according to the second embodiment;

FIG. 10 is a table showing the signal intensity according to the second embodiment; and

FIG. 11 is a block diagram showing the configuration of a computer for executing a program.

### DESCRIPTION OF THE EMBODIMENTS

The present invention proposes a novel method of determining, by a computer, the values of variables to be determined for a plurality of objective functions. Note that situations to which the present invention is applied include a situation in which different objective functions have a trade-off. The method according to the present invention does not always require repeated computation. Also, the variables need not always have discrete values.

In general, a plurality of (n) variables are to be determined by the method according to the present invention. In the method according to the present invention, first, a plurality of (h) response values are computed for the unit amount (for example, one) of an arbitrarily selected variable (for example, the light source intensity). In other words, the response values to each variable are not independent of this variable, but have a linear or nonlinear relationship with this variable. Response values are computed for all the variables and, for example, (n×h) response values are computed. The numbers n and h are not limited. Next, the values (evaluation values) of objective functions are computed. Evaluation values are computed for the n variables, respectively, and used to determine the degrees the variables satisfy in the objective functions. The evaluation value is defined as a function of the response value. Evaluation values are computed using, for example, (n×h) response values.

An evaluation value originally defined as a function nonlinear with respect to the response value may be defined as a linear function. This method is the so-called linear approximation. In this specification, an objective function having an evaluation value represented as a function which has a linear relationship with the variable will be referred to as a first objective function, and an objective function having an evaluation value represented as a function which has a nonlinear relationship with the variable will be referred to as a second objective function. Hence, the first objective function includes an objective function having an evaluation value defined as a function which has a linear relationship with the variable by the above-mentioned linear approximation. Basically, objective functions are associated with evaluation values which evaluate them in a one-to-one correspondence. Therefore, when M objective functions are present, M evaluation values are present as well. Evaluation values are often computed at a plurality of (i) evaluation positions. In this case, (M×i) evaluation values are obtained for one variable. The numbers M and i are not limited. Also, in a special case, an objective function can be evaluated without using an evaluation value. At this time, less than (M×i) evaluation values are obtained for one variable. Processes in this case will be described in detail later in the embodiments.

In the method according to the present invention, each evaluation value is classified into an N or L type. The N- and L-type evaluation values undergo different processes, as will be described below. If the N-type evaluation value is smaller than a threshold, the value of the variable is set to a predetermined value determined in advance, for example, zero. On the other hand, if the N-type evaluation value is equal to or larger than the threshold, the value of the variable is temporarily set to another value, for example, one. A variable having a value set to a nonzero value is defined as an accepted element, and a variable having a value set to zero is defined as an unaccepted element. The accepted element can be changed by adjusting the value temporarily set using the L-type evaluation value. A threshold can be set more easily and more effectively when the N-type evaluation value has a nonlinear relationship with the variable than when it has a linear relationship with the variable. Also, a threshold can be set more easily and more effectively when the N-type evaluation value is a discrete evaluation value than when it is a continuous evaluation value. The use of the L-type evaluation value is more effective when it has a linear relationship with the variable than when it has a nonlinear relationship with the variable. Also, the use of the L-type evaluation value is more effective when it is a continuous evaluation value than when it is a discrete evaluation value. The value of the variable adjusted based on the L-type evaluation value is desirably determined upon confirming the final performance. The final performance can be determined by evaluating an evaluation value, evaluated using linear approximation, using a nonlinear relation again. Also, the step of adjusting the value of an element determined as an unaccepted element based on the N-type evaluation value to a nonzero value may be provided. Adjustment in this step is performed using the L-type evaluation value as well. After adjustment and confirmation of the final performance, the value of the variable can be determined. Confirmation of the final performance or the performance obtained in the course of determining the value of the variable is not the essence of the method according to the present invention, and can be omitted. Changing the threshold makes it possible to adjust the performance of an objective function evaluated based on the N-type evaluation value. Also, changing the target value makes it possible to adjust the performance of an objective function evaluated based on the L-type evaluation value. A method of effectively determining the value of the variable in this way is an essence of the present invention.

In the method according to the present invention, two-step optimization is performed to classify a plurality of different objective functions into N and L types based on, for example, the response characteristics to the variables, thereby optimizing them. Typically, the N-type objective function is a second objective function represented as a function which has a nonlinear relationship with the variable, and the L-type objective function is a first objective function represented as a function which has a linear relationship with the variable. This two-step optimization is different from that described in Japanese Patent Laid-Open No. 2002-261004, which is used to take a plurality of local optimum solutions of an objective function of interest into consideration. Nevertheless, the method according to the present invention does not exclude a problem in which one objective function has a plurality of local optimum solutions. In the method according to the present invention, the level of contribution of each individual objective function is determined so that all the plurality of objective functions are satisfied. Therefore, a plurality of local optimum solutions of each individual objective function are evaluated and limited based on the consistency with other objective functions. In other words, an appropriate one of a plurality of local optimum solutions of one objective function is selected in consideration of other objective functions. The effect of effectively optimizing a plurality of objective functions with little computation is greater in the method according to the present invention than in that described in Japanese Patent Laid-Open No. 2002-261004. The present invention is especially suitable for determining light source data for use in lithography. In addition, the present invention can also be used for a method of generating a digital image for an objective function formed by a plurality of image quality evaluation indices, a method of designing an optical system using an objective function to minimize a plurality of types of aberrations, and a method of adjusting the optical system.

A method of determining light source data of an exposure apparatus used to form, for example, the circuit patterns of an integrated circuit and other devices by photolithography will be described hereinafter as a detailed example of the present invention. The exposure apparatus forms, on a substrate positioned on the image plane of a projection optical system, an image of the pattern of an original (mask, reticle) illuminated with light emitted by an illumination optical system. To accurately form a desired circuit pattern, it is generally necessary to adjust light source data so that it has a performance suitable for a plurality of objective functions. The light source data means a light intensity distribution to be formed on the pupil plane of the illumination optical system, and is sometimes called an effective light source. The objective function describes, for example, the hole barycentric position, hole size, hole shape, hole NILS (Normalized Image Log-Slope), and hole DOF (Depth OF Focus) for a circuit pattern formed in a hole shape. The NILS is obtained by multiplying the intensity gradient at a designated position by the value of the width of a target pattern. The intensity gradient at a designated position is sometimes called a log slope. In this specification, a latent image pattern to be formed on a photosensitive agent on a substrate will be referred to as a target pattern. Also, the pattern of an original, which is used to form such a target pattern, will be referred to as an original pattern.

FIG. 11 schematically shows the configuration of a computer (information processing apparatus) for executing a light source data generation program according to an embodiment of the present invention. The computer includes a bus line 10, control unit 20, display unit 30, storage unit 40, input unit 60, and medium interface 70. The control unit 20, display unit 30, storage unit 40, input unit 60, and medium interface 70 are connected to each other via the bus line 10. The medium interface 70 can be connected to a recording medium 80. The storage unit 40 stores target pattern data 40a, light source data 40b, original data 40c, projection optical system data 40d, resist data 40e, evaluation condition data 40f, and a light source data generation program 40g. The light source data 40b includes data for dividing the pupil plane in a grid pattern to create light source elements. The original data 40c, projection optical system data 40d, resist data 40e, and evaluation condition data 40f are pieces of information associated with an original, a projection optical system, a resist, and evaluation conditions, respectively, and the light source data generation program 40g is executed by referring to these pieces of information. The evaluation conditions include, for example, setting of an evaluation pattern in a target pattern, setting of evaluation values for evaluating objective functions (to be described later), determination as to whether an original pattern is to be adjusted, and the type (for example, the CD or NILS (to be described later)) of imaging performance for evaluating characteristics associated with the original pattern when this adjustment is to be performed.

The control unit 20 is, for example, a CPU, a GPU, a DSP, or a microcomputer, and can include a cache memory for temporary storage. The display unit 30 includes display devices such as a CRT display and a liquid crystal display. The storage unit 40 includes memory devices such as a semiconductor memory and a hard disk. The input unit 60 includes, for example, a keyboard and mouse. The medium interface 70 includes, for example, a USB interface and a medium drive such as a CD-ROM. The recording medium 80 includes recording mediums such as a USB memory and a medium such as a CD-ROM.

As an example of a method of executing the light source data generation program 40g, the recording medium 80 on which the light source data generation program 40g is recorded is connected to the medium interface 70, and the light source data generation program 40g is installed on the computer. This installation includes storing a copy of the light source data generation program 40g in the storage unit 40. The input unit 60 receives a startup command for the light source data generation program 40g, which is input by the user. The control unit 20 receives the startup command for the light source data generation program 40g, and starts up the light source data generation program 40g by referring to the storage unit 40, based on the startup command.

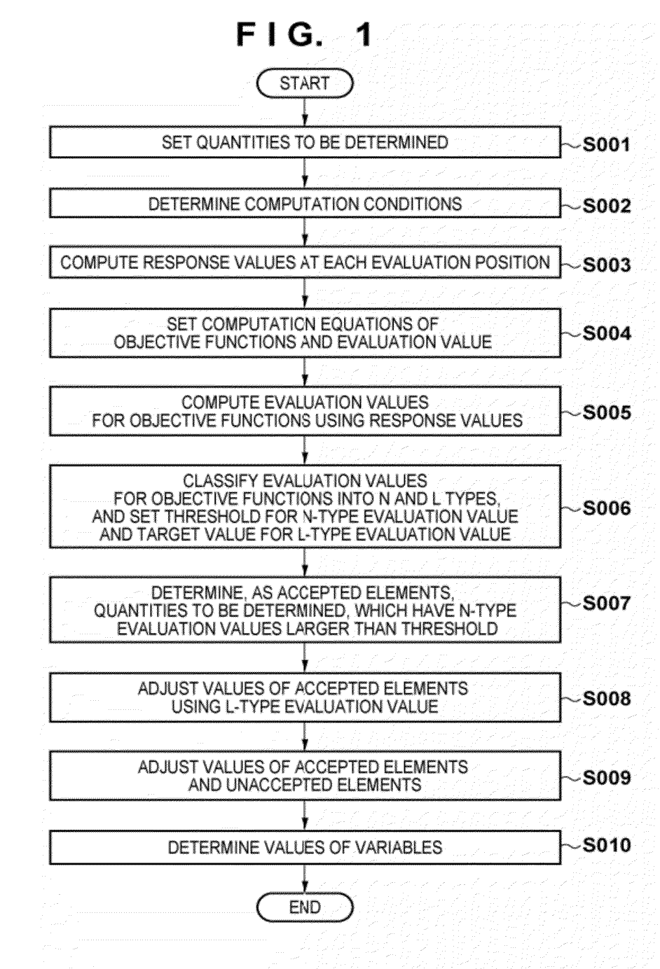

An overview of a process of generating light source data by the light source data generation program 40g will be described with reference to FIG. 1. In step S001, the computer sets variables having values to be determined. The variables having values to be determined include, for example, light source data. The light source data means a light intensity to be formed in each light source element which forms a light source. Each light source element is set by, for example, dividing the pupil plane of an illumination optical system, and determining a plurality of divided regions as light source elements. The number of light source elements serving as variables is, for example, n.

In step S002, the computer determines the computation conditions from the data, stored in the storage unit 40, in accordance with input from the user. The computation conditions include, for example, the target pattern, the exposure wavelength, the original pattern, the NA (Numerical Aperture) of the projection optical system, the refractive index of an immersion liquid if it is used, the refractive index of a resist, and the amount of defocus. Also, response values and evaluation positions at which the evaluation values are computed are set as well in subsequent steps. The evaluation positions are set as, for example, positions defined on the image plane of the projection optical system. Positions at which it is especially hard to obtain a given performance in forming a target pattern are desirably designated as the evaluation positions.

In step S003, the computer sets response value computation equations and computes response values. More specifically, the computer calculates the light intensity of each light source element on the image plane when the light intensity of one light source element is a unit amount (for example, one), and those of all other light source elements are zero (first step). The response values to each variable are not independent of this variable, but have a linear or nonlinear relationship with this variable. A value (image intensity value) at each evaluation position for an image intensity distribution formed on the image plane of the projection optical system by light source elements having a unit intensity, and the NILS value at this evaluation position, for example, serve as response values. Calculation methods will be described in more detail later in the embodiments.

In step S004, the computer sets objective functions. Note that examples of the objective functions include a function describing the accuracy of the position of a main pattern which forms a pattern, a function describing the uniformity of the size of the main pattern, a function describing the accuracy of the shape of the main pattern, a function describing the NILS of the pattern, a function describing the depth of focus, and a function describing resolution/non-resolution of auxiliary patterns which form the pattern.

Also, the computer defines calculation equations used to calculate evaluation values for evaluating the objective functions from the response values computed in step S003. A calculation equation used to calculate an evaluation value for evaluating, for example, the accuracy of the shape of the main pattern from the image intensity value serving as a response value is defined. At this time, the accuracy of the shape of the main pattern has a nonlinear relationship with the variable, but an evaluation value obtained by linear approximation may be used. The linear approximation will be described in detail later. Also, the objective functions do not always have corresponding evaluation values, as described earlier. This holds true for, for example, an objective function describing the depth of focus according to the first embodiment. Details of this objective function will be described later. In step S005, the computer calculates evaluation values at each evaluation position from the response values using the evaluation value calculation equations defined in step S004 (second step).

In step S006, the computer classifies the evaluation values calculated in step S005 into N and L types. In classifying these evaluation values into N and L types, the user may be allowed to arbitrarily set the N or L type, or the condition under which each evaluation value is determined as the N or L type may be set in advance. Alternatively, an evaluation value corresponding to an objective function may be classified into the N or L type in accordance with the type of objective function, or may be classified into the N or L type in accordance with the sign or absolute value of the evaluation value. It is often the case that a threshold is set for the N-type evaluation value, and a target value is set for the L-type evaluation value. For example, in the first embodiment, the N-type evaluation value is an evaluation value for the NILS, and the L-type evaluation value is an evaluation value for the hole barycentric position, hole size, and hole shape. Computation will be described in more detail later in the embodiments.

In step S007, the computer determines, as accepted elements, variables (light source elements) having N-type evaluation values larger than the threshold, temporarily sets the intensity values of the accepted elements to one, and the intensity values of elements other than the accepted elements to zero (third step). In step S008, the computer adjusts the values of the accepted elements in accordance with the absolute values of the L-type evaluation values (fourth step). Examples of this adjustment include adjustment while the values of the elements other than the accepted elements remain zero, and adjustment while changing the values of the elements other than the accepted elements. This adjustment also includes determining the accuracy of linear approximation to change the amount of adjustment. An adjustment method in this step will be described in more detail later.

In step S009, the computer adjusts the values of the variables having the intensity distribution adjusted in step S008, using, for example, the imaging computation result or exposure result. This adjustment is desirably performed based on a precise result obtained without using linear approximation. This step can be omitted. In step S010, the computer determines, as the values of the variables, the values obtained in step S009, and this sequence ends.

Although a case in which a series of processes in the method according to the present invention is applied to light source determination has been described herein, this method is also applicable to determination of other data. Examples are determination of data used to generate a digital image, and determination of design value data and adjustment amount data of an optical system. In generating a digital image, there are a plurality of objective functions which use a noise reduction and a sharpness improvement as evaluation indices for image characteristics. Examples of the variables for these objective functions include the pupil filter transmittance distribution and the signal intensity amplification distribution. In design and adjustment of an optical system, there are a plurality of objective functions intended to correct a plurality of types of aberrations such as spherical aberration and coma, ensure a given back focus, and downsize an optical system. Examples of the variables for these objective functions include the radius of curvature, refractive index, and interplanar spacing of a lens.

In generating a digital image, in step S006, the objective function to be evaluated may change and the type of evaluation value may, in turn, change between the N and L types as well, depending on whether evaluation values are to be computed using both positive and negative response values of one type or using only positive response values of this type. In this respect, digital image generation is different from light source data generation. In this manner, a method of determining the values of the variables for a plurality of objective functions is not limited to light source data, and is applicable to other data. Hence, the target to which the present invention is applied is not limited to only the following embodiments.

### First Embodiment

In the first embodiment, the computer determines light source data used for an exposure apparatus, based on a plurality of objective functions. The method according to the present invention will be described, referring back to steps in FIG. 1. In step S001, the computer sets a variable. In this case, light source data used for an exposure apparatus is used as the variable. The light source data represents the light intensity distribution of a light source. The light intensity distribution of a light source is the distribution of independent light intensity values of a plurality of light source elements. The light source elements are set by dividing the pupil plane (frequency space) of an illumination optical system in a grid pattern. A single grid may be defined as one light source element, or a set of a plurality of grids that fall within a range having a predetermined width in the radial direction of the pupil and a predetermined angle of rotation from the abscissa to the ordinate in the pupil may be defined as one light source element. A method of dividing the pupil in a grid pattern, and a method of setting light source elements are not the essential features of the method according to the present invention, and general methods may be employed.

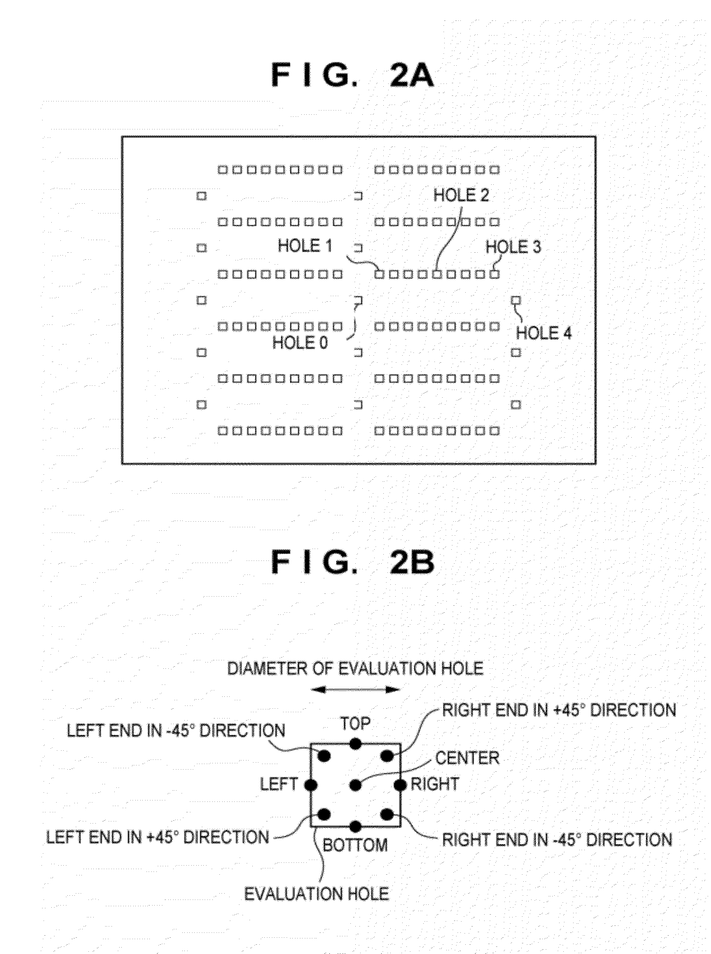

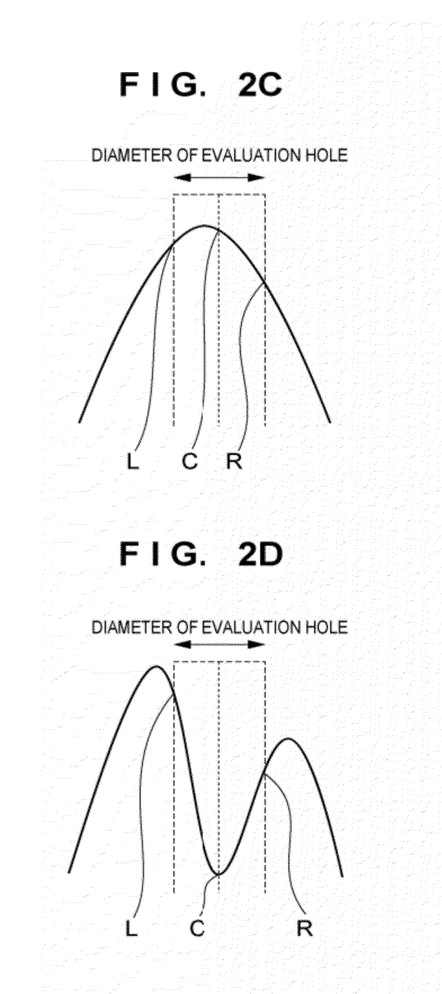

In step S002, the computer determines the computation conditions. The resist is assumed to be a positive resist having a through hole pattern formed in portions having light intensities equal to or higher than a predetermined threshold. The exposure apparatus is assumed to use a projection optical system having an NA of 0.86, and light which is used for exposure and has a wavelength (λ) of 248 nm. The type of polarized light is assumed to be circularly polarized light. The projection optical system is assumed to have no aberration and a projection magnification of 0.25×. The original is assumed to be a binary mask. The target pattern is assumed to be a hole pattern including holes having a diameter of 100 nm, as illustrated in FIG. 2A. The original pattern is assumed to be equal to the target pattern in consideration of the projection magnification. Positions (evaluation holes) at which an objective function to be defined later is evaluated are set. In this case, five evaluation holes are set, as illustrated in FIG. 2A. These evaluation holes are defined as holes 0, 1, 2, 3, and 4. The number of evaluation holes is not limited, and can arbitrarily be selected in practice. For example, all the holes may be evaluated based only on their contrasts, and low-contrast holes may be selected as the evaluation holes. The amount of defocus corresponding to the position of the image plane of the projection optical system is assumed to be zero, and the amount of defocus corresponding to the position of a specific image plane is assumed to be 100 nm. These conditions are set by the computation executor, and determined as the computation conditions in step S002 of FIG. 1.

In step S003, the computer computes a plurality of response values at each evaluation position. The response values include the intensity value and NILS value of an optical image formed at a specific position on the image plane when light source elements are illuminated at a unit intensity. The image plane has the amount of defocus of 100 nm, which is set in step S002. The image intensity value and NILS value are obtained for each of the five evaluation holes (main pattern). As shown in FIG. 2B, the intensity values at a total of nine points including five points: the top, bottom, right, and lower ends, and the center of an evaluation hole; and four points: the right and left ends of each of its cross-sections in the ±45° directions, are obtained for each evaluation hole. The intensity values at the top, bottom, right, and left ends of each evaluation hole, and the right and left ends of each of its cross-sections in the ±45° directions represent the intensities at a plurality of points on the peripheral edge of an optical image of the main pattern, and that at the center of the evaluation hole represents the intensity at the center of the optical image of the main pattern. The number h of response values to each evaluation hole is 10 from the intensity values at the nine points and one NILS value. Although one NILS value is used herein, this value precisely means the average of the NILS values at four points at the two ends of each of the cross-sections in the ±45° directions. Since five evaluation holes i are present, 5×10=50 response values are computed for each light source element.

In step S004, the computer sets M objective functions and evaluation value computation equations used to evaluate the objective functions. The objective functions describe the uniformity of the size of each evaluation hole, the accuracy of the barycentric position of this evaluation hole, the fidelity of the shape of this evaluation hole, the NILS of this evaluation hole, and the depth of focus of this evaluation hole. The number M of objective functions is five. Although the numbers of objective functions and evaluation holes are the same, they need not always be the same in general, and the number M is not limited. Among the five objective functions, the objective function describing the depth of focus represents the defocus characteristics. The depth of focus can be taken into consideration by the following method without directly computing an evaluation value corresponding to the depth of focus. In this method, image information is obtained by defocusing the focal plane in imaging computation. The remaining objective functions (for example, the accuracy of the hole shape) are computed from the defocus image information, and the evaluation values for these objective functions are taken into consideration, thereby improving the evaluation values on the defocus plane. This makes it possible to indirectly increase the depth of focus. In this case, response values are obtained based on the defocus plane (an amount of defocus of 100 nm). This method is based on the past experience that a light source distribution which improves the depth of focus more can be obtained when response values on the defocus plane are used rather than when response values are obtained on a best focus plane (an amount of defocus of 0 nm) to determine the light source distribution. Therefore, no evaluation value is set for the depth of focus. The depth of focus may be evaluated by setting an evaluation value defined by the difference between the response values on the defocus plane and best focus plane, although this is not done in this embodiment. The NILS value computed at a predetermined defocus position on the defocus plane (an amount of defocus of 100 nm) is defined as the evaluation value for the NILS of each evaluation hole. In this case, the NILS value serving as an evaluation value is defined as the average NILS of the NILSs in cross-sections in the ±45° directions. As the remaining three evaluation values representing the uniformity of the size of each evaluation hole, the accuracy of the barycentric position of this evaluation hole, and the fidelity of the shape of this evaluation hole, evaluation values obtained by linear approximation using a triangular image intensity approximation method to be described below are used. In general, the light source intensity value and the image intensity value have a linear relationship with each other. Accordingly, an evaluation value computed using a linear expression describing the image intensity value has a linear relationship with the light source intensity value (variable). A method of computing an evaluation value using a linear expression describing the image intensity value is not limited to triangular image intensity approximation. The linear approximation method used in the method according to the present invention is not limited to the triangular image intensity approximation method, either.

In the triangular image intensity approximation, the intensity distribution at the position of each evaluation hole is approximated by three points: the two ends and center of this evaluation hole in an image intensity distribution formed by light source elements. Since a through hole pattern is formed using a positive resist, the image intensity can be increased at the position of each evaluation hole. The intensity C at the central position of each evaluation hole, shown in FIG. 2C is defined as the evaluation value for the hole size. As the variance among the values of the intensity C serving as an evaluation value for each evaluation hole reduces, the evaluation result of the uniformity of the size of this evaluation hole gets better. The evaluation value for the accuracy of the barycentric position of each evaluation hole is (Intensity C−Intensity L+Intensity C−Intensity R) in FIG. 2C. As the evaluation value becomes a larger positive value, an intensity peak is formed closer to the center of each evaluation hole. As shown in FIG. 2D, if the evaluation value is negative, an intensity peak is not formed closer to the center of each evaluation hole. The evaluation value for the fidelity of the shape of each evaluation hole is {(Intensity L in Longitudinal Section+Intensity R in Longitudinal Section)−(Intensity L in Cross-section+Intensity R in Cross-section)}. The shape is deformed into a shape vertically elongated as the evaluation value becomes a larger positive value, and the shape is deformed into a shape horizontally elongated as the evaluation value becomes a larger negative value. As the evaluation value has a smaller absolute value, the deformation becomes smaller, so the evaluation result of the fidelity of the shape of each evaluation hole gets better.

In step S005, the computer computes evaluation values for the objective functions using the response values. In this case, based on the equations defined in step S004, three evaluation values for the uniformity of the size of each evaluation hole, the accuracy of the barycentric position of this evaluation hole, and the fidelity of the shape of this evaluation hole, and an evaluation value for the NILS are computed for this evaluation hole. The average NILS of the NILSs in cross-sections in the ±45° directions is computed as the evaluation value for the NILS, as described earlier. The intensity C at the central position of each evaluation hole is computed as the evaluation value for the size of this evaluation hole. An evaluation value for the barycentric position of each evaluation hole is computed by (Intensity C−Intensity L+Intensity C−Intensity R). An evaluation value for the shape of each evaluation hole is computed by {(Intensity L in Longitudinal Section+Intensity R in Longitudinal Section)−(Intensity L in Cross-section+Intensity R in Cross-section)}.

Note that if the original pattern includes auxiliary patterns, it is often desirable not to resolve the auxiliary patterns. In this case, a function describing resolution/non-resolution of the auxiliary patterns can be added as an objective function. For example, upon defining, as an evaluation value, the intensity value at the image position corresponding to the central position of each auxiliary pattern, light source data serving as a variable can be adjusted and determined in subsequent steps.

In step S006, the computer classifies the evaluation values for the objective functions into N and L types. The N-type evaluation value is the evaluation value for an objective function describing the NILS, that is, the NILS value. The N-type evaluation value has, for example, a nonlinear relationship with the light intensity distribution, and the NILS has a nonlinear relationship with the variable. The L-type evaluation value includes three evaluation values corresponding to three objective functions describing the uniformity of the size of each evaluation hole, the accuracy of the position (barycentric position) of this evaluation hole, and the accuracy of the shape of this evaluation hole. These three evaluation values have linear relationships with the variable by triangular image intensity approximation. The L-type evaluation value has, for example, a linear relationship with the variable. The depth of focus is taken into consideration by obtaining the image intensity on the defocus plane, without directly measuring an evaluation value corresponding to the depth of focus, as described earlier. Also, in this step, the computer sets a threshold for the N-type evaluation value. Moreover, in this step, the computer sets a target value for the L-type evaluation value. A detailed threshold and target value are not the essential features of the present invention, and will not be clearly described.

In step S007, the computer selects, as accepted elements, light source elements having NILS evaluation values, that is, N-type evaluation values larger than the threshold. Light source elements other than the accepted elements are determined as unaccepted elements. The computer assigns a predetermined intensity value (for example, one) to the accepted elements, and zero intensity value to the unaccepted elements. Before determining a detailed intensity value (intensity value) for each light source element in a subsequent step, the computer sets a binarized intensity distribution in this step. As an example, in step S007, the light source elements are filtered out using a filter having an intensity of 1/0. The computer determines the detailed intensities of the accepted elements in a subsequent step. In this case, it is of prime importance to determine unaccepted elements so as to considerably decrease the number of elements for which detailed intensity values are determined. This makes it possible to shorten the computation time, thus effectively determining the value of the variable.

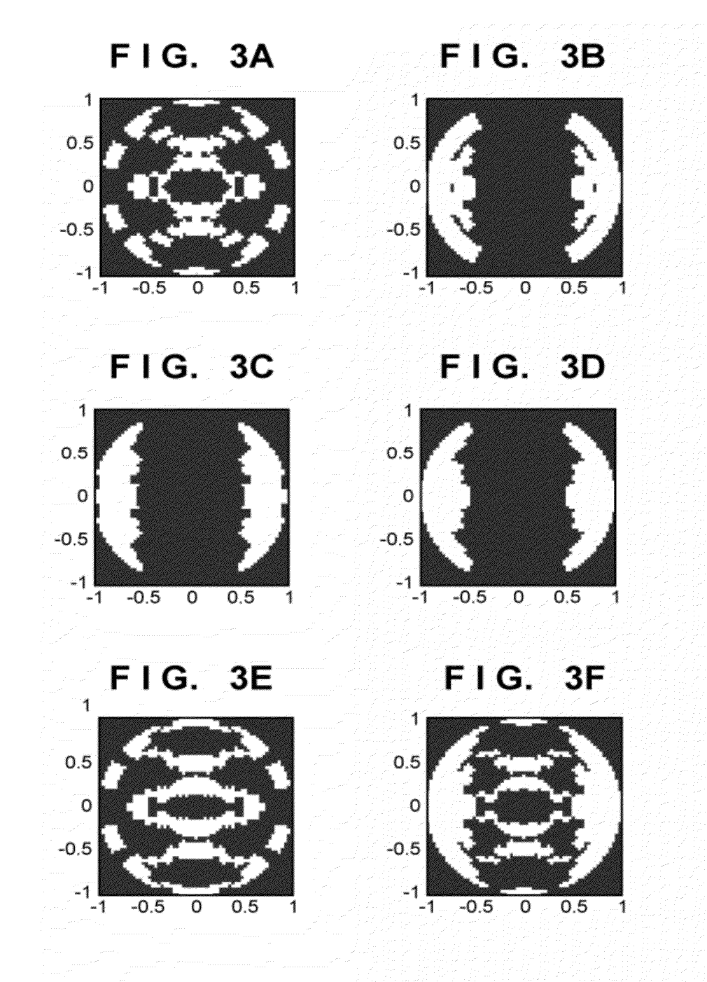

The threshold used to determine accepted/unaccepted elements may be the same or vary in all evaluation holes. In this case, this threshold is set to a value which varies in each individual evaluation hole so that the number of light source elements accepted in each individual evaluation hole is practically the same. The computer sets the intensity values of light source elements to zero or one in evaluation holes 0 to 4 using the threshold. FIGS. 3A to 3E show light source elements having intensity values set to one in evaluation holes 0 to 4. Light portions indicate light source elements having an intensity value of one, and dark portions indicate light source elements having zero intensity value. Although various methods of determining accepted elements are available, the following method is adopted herein. The computer sums up the five distributions of light source elements, shown in FIGS. 3A to 3E, in individual holes first. The summed distribution has intensity values of zero to five. The computer selects, as accepted elements, elements having values of two or more in this distribution. FIG. 3F shows the accepted elements determined by this method. Note that all the accepted elements have the same intensity. The intensities of the accepted elements are defined as, for example, a unit intensity. The intensities of light source elements other than the accepted elements are defined as zero. In the light source elements, when a constraint is to be imposed on the maximum values (outer sigma values) of elements having given values in the pupil radius direction, light source elements can be accepted using a threshold within the range of sigma values smaller than a preset sigma value, and the intensities of light source elements having sigma values larger than the preset sigma value can be set to zero. In this embodiment, no constraint is assumed to be imposed on the outer sigma value. Note that circularly polarized light is assumed to be used in this embodiment. However, when the NILS value is computed by changing the type of polarized light, computing and comparing NILS values corresponding to the respective types of polarized light, and determining the maximum NILS value and the angle of polarization, at which the NILS maximizes, the angle of polarization can be adjusted without limiting the type of polarized light to circularly polarized light. In adjusting the angle of polarization, a value obtained at the angle of polarization at which the NILS maximizes, is used as an image intensity value serving as a response value used to calculate the size, barycentric position, and shape of each evaluation hole.

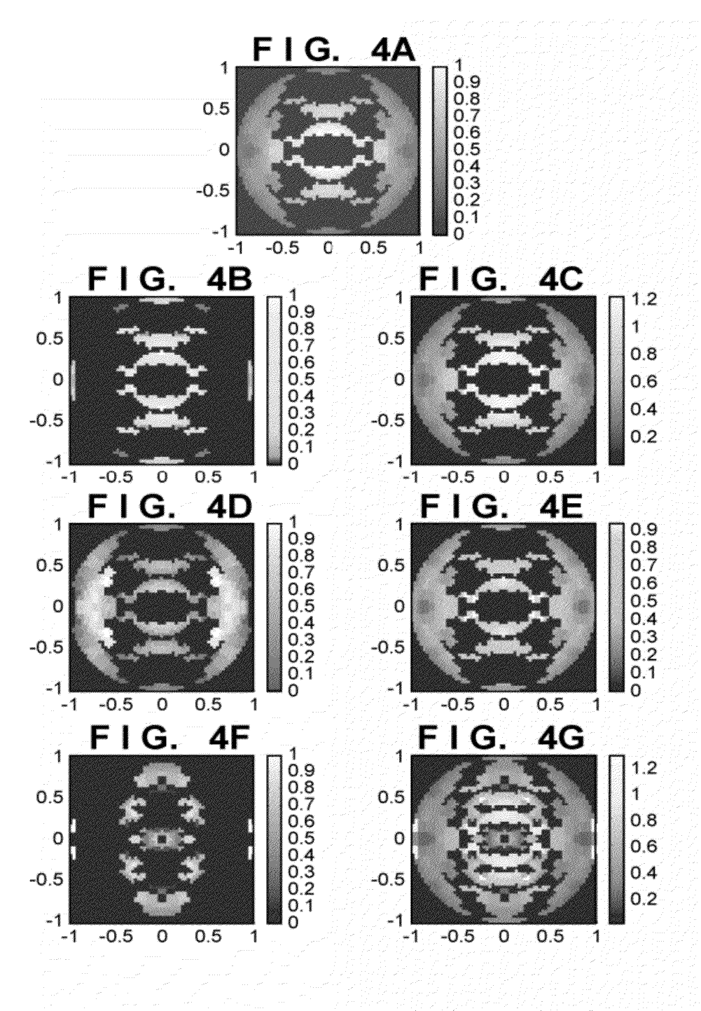

In step S008, the computer adjusts the intensity values of the accepted elements, obtained in step S007, using the L-type evaluation values. Although various detailed adjustment methods are available within the scope of the method according to the present invention, the intensity values of the accepted elements are adjusted by determining an initial light source distribution and performing three-step adjustment for the initial light source distribution. Adjustment operations in the three-step adjustment will be referred to as positive adjustment, negative adjustment, and add adjustment hereinafter. Determination of an initial light source distribution will be described first. An initial light source distribution is determined using the L-type evaluation values. More specifically, an example of the L-type evaluation values is an evaluation value for the size of hole 4 that is a minimum hole among the evaluation holes. The distribution of this evaluation value is determined as an initial light source distribution. In other words, the L-type evaluation value (an evaluation value for the size of hole 4) corresponding to each light source element is set as the intensity value of this light source element. FIG. 4A shows the thus set initial distribution. Positive adjustment, negative adjustment, and add adjustment are performed for the initial light source distribution. The step of determining the initial light source distribution can be omitted, and positive adjustment, negative adjustment, and add adjustment may be performed for accepted light source elements having an intensity value of 1.

The L-type evaluation value includes three evaluation values describing the uniformity of the size of each evaluation hole, the accuracy of the barycentric position of this evaluation hole, and the accuracy of the shape of this evaluation hole. The computer determines a light source element which improves at least one evaluation value that falls below a target value, for each of these three evaluation values. The computer determines, for example, an evaluation hole having an evaluation value (worst evaluation value) farthest from a target value. From the evaluation value for the size of each evaluation hole, it is determined that hole 2 has a maximum hole diameter, and hole 4 has a minimum hole diameter. The computer adjusts the accepted elements so as to increase the size of hole 4, using the difference in evaluation value between holes 4 and 2. Hole 4 is an evaluation hole having a worst evaluation value for the barycentric position of each evaluation hole. On the other hand, hole 2 is an evaluation hole having a best evaluation value for the barycentric position of each evaluation hole. Using the difference in evaluation value between holes 4 and 2, the computer adjusts the accepted elements so as to improve the barycentric position of hole 4. Hole 2 is an evaluation hole having a worst evaluation value for the fidelity of the shape of each evaluation hole. As can be seen from the fact that hole 2 has a large positive evaluation value, hole 2 has a large vertical deformation. The computer adjusts the accepted elements to reduce the vertical deformation of hole 2 so as to improve the fidelity of the shape. In other words, the difference between the evaluation values of holes 4 and 2 is used for the hole size, the difference between the evaluation values of holes 4 and 2 is used for the hole barycentric position, and the evaluation value for hole 2 is used for the hole shape. The computer performs positive adjustment using evaluation values which improve worst evaluation values corresponding to these three objective functions, and negative adjustment and add adjustment are then performed, thereby adjusting the values of the accepted elements.

Positive adjustment, negative adjustment, and add adjustment will be sequentially described below. Positive adjustment is done by increasing the intensity values of light source elements (positive adjustment elements) which improve worst evaluation values for all the L-type evaluation values (size, position, and shape). Note that the positive adjustment elements are selected from the accepted elements.

Various detailed methods of determining positive adjustment elements are available. In this case, the computer, for example, selects positive adjustment elements in accordance with condition A, and determines the intensity value of the selected positive adjustment element in accordance with condition B. Condition A is determined as the condition in which the evaluation value for the size of hole 4 is larger than those for the sizes of all the remaining evaluation holes, the evaluation value for the barycentric position of hole 4 is larger than those for the barycentric positions of all the remaining evaluation holes, and the evaluation value for hole 2 is negative and exhibits a horizontally elongated shape. Condition B is determined as {(Evaluation Value for Size of Hole 4−Evaluation Value for Size of Hole 2+Evaluation Value for Barycentric Position of Hole 4−Evaluation Value for Barycentric Position of Hole 2−Negative Evaluation Value for Shape of Hole 2)}. FIG. 4B shows positive adjustment elements which are selected in accordance with condition A, and have intensity values that satisfy condition B. A method of determining positive adjustment elements is not limited to this. The computer may determine positive adjustment elements using, for example, an amount different from that defined by condition B for all the accepted elements without selecting them in accordance with condition A.

The computer performs positive adjustment by adding a value obtained by multiplying positive adjustment elements by a constant CP to the initial distribution. The constant CP is determined so that the worst evaluation value (for example, the evaluation value for the hole size) of one of the three L-type evaluation values becomes equal to the second worst evaluation value. Adjustment using the L-type evaluation values obtained using linear approximation in this way makes it possible to effectively adjust the values of quantities to be determined with little repeated computation, unlike the prior art technique. This holds true for negative adjustment and add adjustment as well.

FIG. 4C shows the intensity distribution of the accepted elements after positive adjustment. The computer obtains three L-type evaluation values corresponding to the intensity distribution of these light source elements, and calculates worst evaluation values again, thereby performing negative adjustment using these evaluation values. Note that before negative adjustment, the computer may confirm the validity of the positive adjustment result and adjust the values using this result. Since this confirmation is intended to confirm the effectiveness of linear approximation, the values of the hole size, shape, and barycentric position which are not approximated linearly are desirably confirmed based on the positive adjustment result. A method of confirming the validity of positive adjustment to adjust those values will not be described in this embodiment.

Negative adjustment is done by decreasing the intensity values of light source elements which worsen worst evaluation values for all the L-type evaluation values (size, position, and shape). Note that the negative adjustment elements are selected from the accepted elements. The computer determines the worst evaluation values after positive adjustment, based on the size, barycentric position, and shape. As for the size of each evaluation hole, hole 2 has the maximum size, and hole 4 has the minimum size. The computer adjusts the light source elements so as to increase the size of hole 4, using the difference between the evaluation values of holes 4 and 2. Hole 4 is an evaluation hole having the worst evaluation value for the barycentric position of each evaluation hole. On the other hand, hole 2 is an evaluation hole having the best evaluation value for the barycentric position of each evaluation hole. Using the difference between the evaluation values of holes 4 and 2, the computer adjusts the light source elements so as to improve the barycentric position of hole 4. Hole 1 is an evaluation hole having the worst evaluation value for the fidelity of the shape of each evaluation hole. As can be seen from the fact that hole 1 has the large negative evaluation value, hole 1 has a large horizontal deformation. The computer adjusts the light source elements to reduce the horizontal deformation of hole 1 so as to improve the fidelity of the shape. In other words, the computer performs negative adjustment using the difference in evaluation value between holes 4 and 2 for the hole size, using the difference in evaluation value between holes 4 and 2 for the hole barycentric position, and using the evaluation value for hole 1 for the hole shape.

Various detailed methods of determining negative adjustment elements are available. The computer selects, for example, light source elements which satisfy the condition in which the evaluation value for the size of hole 4 is smallest among those for the sizes of all the remaining evaluation holes, the evaluation value for the barycentric position of hole 4 is smaller than that for the barycentric position of hole 2, and the evaluation value for hole 1 is negative and exhibits a horizontally elongated shape. The intensity distribution of the selected light source elements is {(Evaluation Value for Size of Hole 2−Evaluation Value for Size of Hole 4+Evaluation Value for Barycentric Position of Hole 2−Evaluation Value for Barycentric Position of Hole 4−Positive Evaluation Value for Hole 1)}. FIG. 4D shows negative adjustment elements determined in accordance with this condition.

The computer performs negative adjustment by subtracting the value obtained by multiplying these negative adjustment elements by a constant CM from the distribution after positive adjustment. The constant CM is determined so that the worst evaluation value (for example, the evaluation value for the hole size) of one of the three L-type evaluation values becomes equal to the second worst evaluation value. FIG. 4E shows the intensity distribution of the accepted elements after negative adjustment. The computer obtains three L-type evaluation values corresponding to the intensity distribution of these light source elements, and calculates the worst evaluation values again. If the target values are reached, adjustment ends. If the target values are not reached, the computer performs add adjustment using the worst evaluation values after negative adjustment (fifth step). Note that before add adjustment, the computer may confirm the validity of the negative adjustment result and adjust the values using this result. Since this confirmation is intended to confirm the effectiveness of linear approximation, the values of the hole size, shape, and barycentric position which are not approximated linearly are desirably confirmed based on the negative adjustment result. A method of confirming the validity of negative adjustment to adjust those values will not be described in this embodiment.

Add adjustment is done by increasing the intensity values of light source elements (positive adjustment elements) which improve worst evaluation values for all the L-type evaluation values (size, position, and shape). Note that the add adjustment elements are selected from light source elements other than the accepted light source elements, differently from positive adjustment. The computer sets a new threshold smaller than the threshold set in step S005 for the NILS, that is, N-type evaluation value, and selects again light source elements having intensities other than zero intensity as add adjustment elements. In other words, the computer adds, as accepted elements, light source elements having been determined as unaccepted elements once. The computer adjusts the values using the L-type evaluation values for the newly added light source elements. In this case, the computer obtains a distribution by, for example, improving the worst evaluation value (hole 1) for the shape after negative adjustment, and improving the worst evaluation value (hole 4) with respect to hole 2 for the size, after negative adjustment. More specifically, the computer obtains a distribution defined by {(Positive Evaluation Value for Size of Hole 1+Evaluation Value for Size of Hole 4−Evaluation Value for Size of Hole 2)}. A distribution may be obtained using the evaluation value for the barycentric position. However, in this embodiment, the evaluation value for the barycentric position is not used because a target value is attained for the response value to the barycentric position after negative adjustment, and this means that the evaluation value for the barycentric position of each add adjustment element is so small that the response value to the barycentric position is less likely to degrade upon add adjustment. FIG. 4F shows add adjustment elements determined under this condition.

The computer performs add adjustment by adding a value obtained by multiplying these add adjustment elements by a constant CA to the distribution after negative adjustment. The constant CA is determined so that the worst evaluation value (for example, the evaluation value for the hole size) of one of the three L-type evaluation values becomes equal to the second worst evaluation value.

FIG. 4G shows the intensity distribution of the accepted light source elements after add adjustment. The computer obtains three L-type evaluation values corresponding to the intensity distribution of these light source elements, and calculates the worst evaluation values again. If target values are reached, adjustment ends. If the target values are not reached, the computer sets the target values again, and performs positive adjustment, negative adjustment, or add adjustment again. Alternatively, the computer determines the distribution after add adjustment as light source data. Again, the original pattern may be adjusted (the shape, size, or position of the hole pattern may be corrected). The minimum value of the intensities of the adjustment elements for use in positive, negative, and add adjustment, and the minimum value of the intensities of the light source elements after adjustment can be set to zero or more. If the minimum values are negative, it is desirable to, for example, add constants to all the adjustment elements so that the minimum values become zero. Again, negative adjustment may be performed before positive adjustment.

In step S009, the computer adjusts the light source data using, for example, data obtained by imaging computation. This step can be omitted. In this embodiment, this step is omitted. In step S010, the computer determines light source data. In this embodiment, the computer determines light source data having light source intensities defined in the intensity distribution shown in FIG. 4G after add adjustment.

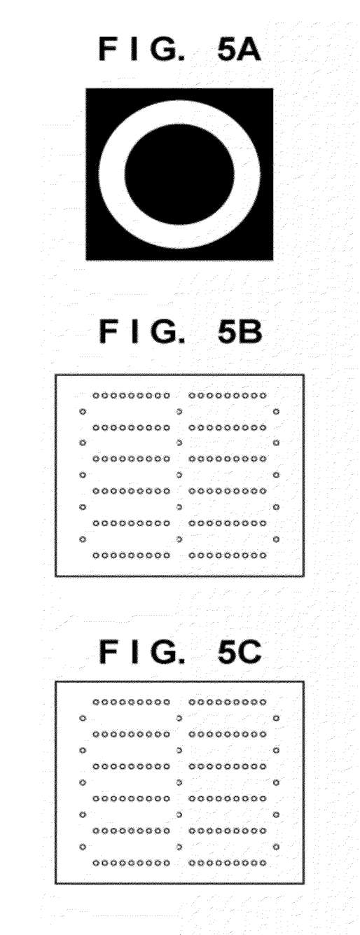

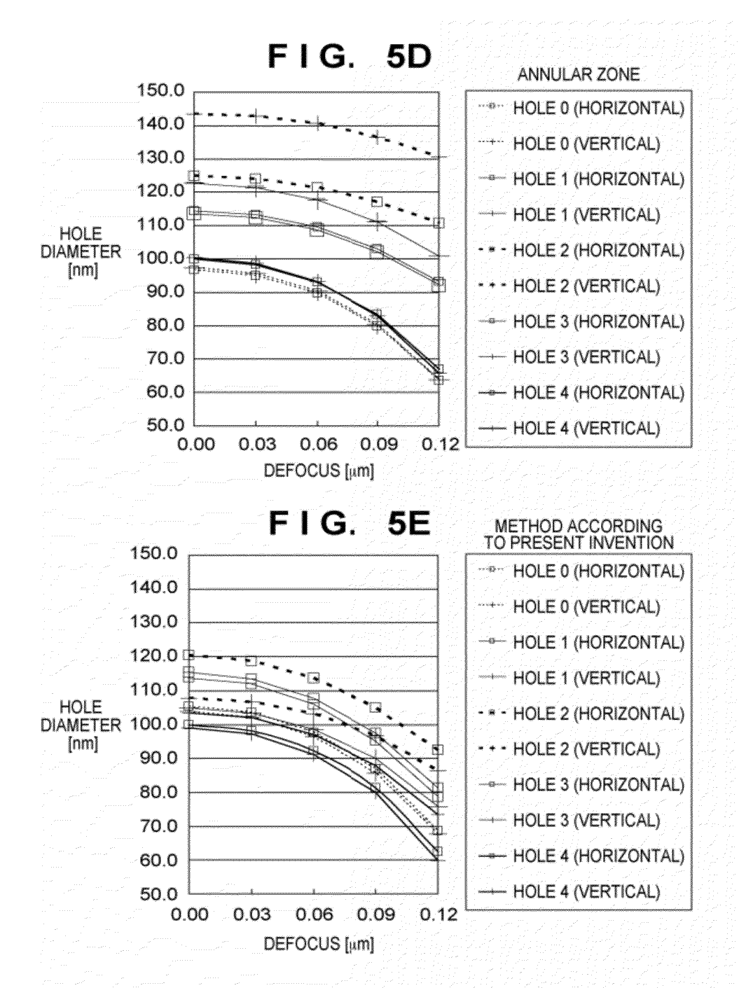

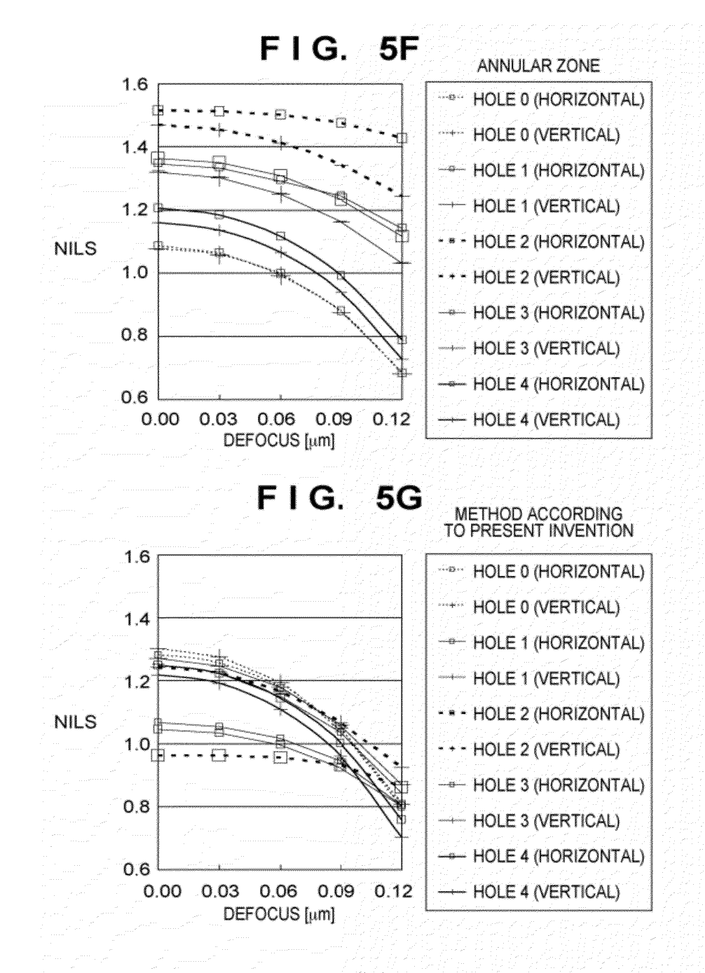

The performance of the light source data determined by the method according to the present invention is confirmed by imaging computation. The object to be compared is an annular light source shown in FIG. 5A. The light source intensity is defined as one in a light portion, and is defined as zero in a dark portion. The annular zone width is assumed to be 0.25, the length from the pupil center to the annular zone center is assumed to be 0.72 corresponding to a half pitch of 100 nm. The type of polarized light is assumed to be circularly polarized light. FIG. 5B shows an aerial image in best focus when the annular light source shown in FIG. 5A is used. FIG. 5C shows an aerial image in best focus when the light source (circularly polarized light) obtained by the method according to the present invention shown in FIG. 4G is used. Both the aerial images are drawn using a slice level at which the horizontal diameter of hole 4 is 100 nm and that at which this diameter is 100 nm±10%. Hole 2 is larger than any other hole, that is, holes 0 and 4 are smaller than hole 2 in the aerial image shown in FIG. 5B when an annular light source is used, unlike that shown in FIG. 5C when the light source obtained by the method according to the present invention is used. Also, the shape of hole 2 is vertically deformed more in the aerial image shown in FIG. 5B than in that shown in FIG. 5C. The hole barycentric position varies little between the annular light source and the light source obtained by the method according to the present invention. FIG. 5D is a graph when the diameter of each evaluation hole in the aerial image formed using the annular light source shown in FIG. 5B is plotted as a function of the defocus. FIG. 5E is a graph when the diameter of each evaluation hole in the aerial image formed using the light source obtained by the method according to the present invention shown in FIG. 4G is plotted as a function of the defocus. As can be seen from FIG. 5D, hole 2 in the annular light source is vertically deformed in an amount of 40 nm or more. The maximum hole diameter in best focus is the vertical diameter of hole 2, that is, 143 nm, and the minimum hole diameter in best focus is the horizontal diameter of hole 0, that is, 97 nm, so their difference is 46 nm. In contrast, in the light source obtained by the method according to the present invention, the maximum hole diameter in best focus is the horizontal diameter of hole 2, that is, 121 nm, and the minimum hole diameter in best focus is the horizontal diameter of hole 0, that is, 99 nm, so their difference is 22 nm. As can be seen from this comparison, the light source obtained by the method according to the present invention attains higher uniformity of the hole size. Also, as can be seen from the graph, the depth of focus does not considerably decrease while improving the uniformity of the hole size. More specifically, at a defocus of 0.12 μm, the minimum hole diameter in the annular light source is the horizontal diameter of hole 0, that is, 63 nm, and that in the light source obtained by the method according to the present invention is the vertical diameter of hole 4, that is, 60 nm. The NILS in the annular light source shown in FIG. 5F, and that in the light source obtained by the method according to the present invention shown in FIG. 5G are compared. The NILS value is lower in the light source obtained by the method according to the present invention than in the annular light source. The horizontal NILS of hole 2 is especially low in the former light source. The hole diameter is kept in good balance by setting the NILS of hole 2 lower in the light source obtained by the method according to the present invention than in the annular light source. It is impossible to improve the whole plurality of objective functions having a trade-off at once, so the method according to the present invention ensures an NILS value equal to or higher than a predetermined value to improve the hole shape. As can be seen from the image intensity distribution shown in FIG. 5C, the light source obtained by the method according to the present invention has a sufficient NILS. The above-mentioned result reveals that the method according to the present invention can obtain a light source which improves five performances: the depth of focus, the NILS, the uniformity of the hole size, the hole barycentric position, and the hole shape for all of the five evaluation holes.

A method of manufacturing a device (for example, a semiconductor device or a liquid crystal display device) according to an embodiment of the present invention will be described next. A semiconductor device is manufactured by a preprocess of forming an integrated circuit on a wafer, and a post-process of completing, as a product, a chip of the integrated circuit formed on the wafer by the preprocess. The preprocess includes a step of exposing a wafer, coated with a photosensitive agent, using an exposure apparatus, and a step of developing the wafer. The post-process includes an assembly step (dicing and bonding) and packaging step (encapsulation). A liquid crystal display device is manufactured by a step of forming a transparent electrode. The step of forming a transparent electrode includes a step of coating a photosensitive agent on a glass substrate on which a transparent conductive film is deposited, a step of exposing the glass substrate, coated with the photosensitive agent, using the above-mentioned exposure apparatus, and a step of developing the glass substrate. The method of manufacturing a device according to this embodiment can manufacture a device with a quality higher than those of devices manufactured by the prior art techniques.

### Second Embodiment

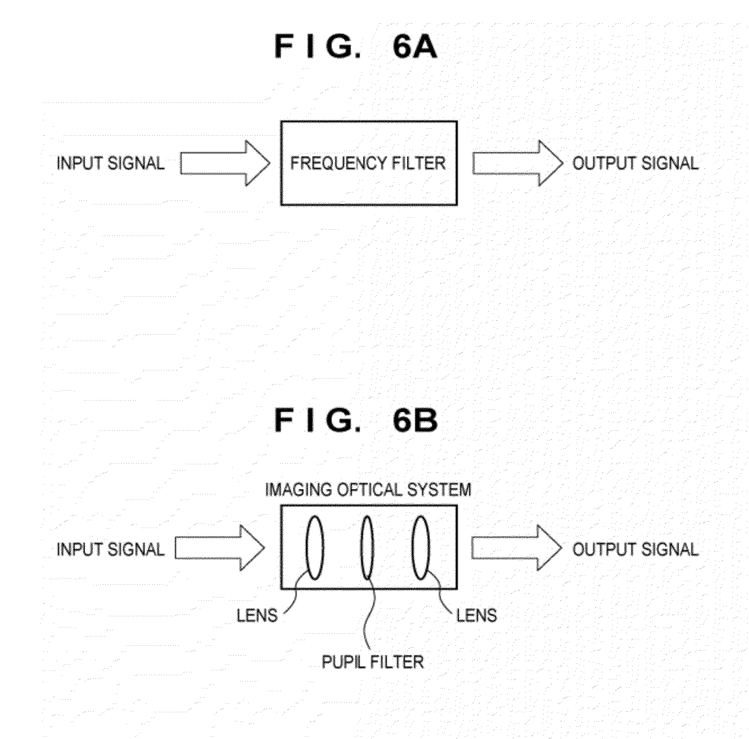

In this embodiment, frequency filter data for adjusting the signal intensity used to generate a digital image is determined. The frequency filter data serving as a variable to be determined is the intensity transmittance in each frequency zone (to be described later). The frequency filter may be a virtual frequency filter obtained by an arithmetic operation. In other words, a frequency filter may be obtained by converting a frequency vs. intensity distribution obtained in advance into an intensity distribution, equivalent to that formed upon passage through a frequency filter, by an arithmetic operation using the transmittance of the frequency filter (see FIG. 6A). Alternatively, the frequency filter may be a pupil filter positioned on the pupil plane of an imaging optical system (see FIG. 6B). Although a filter which changes the intensity transmittance distribution is used in this embodiment, a filter which changes the phase can also be used.

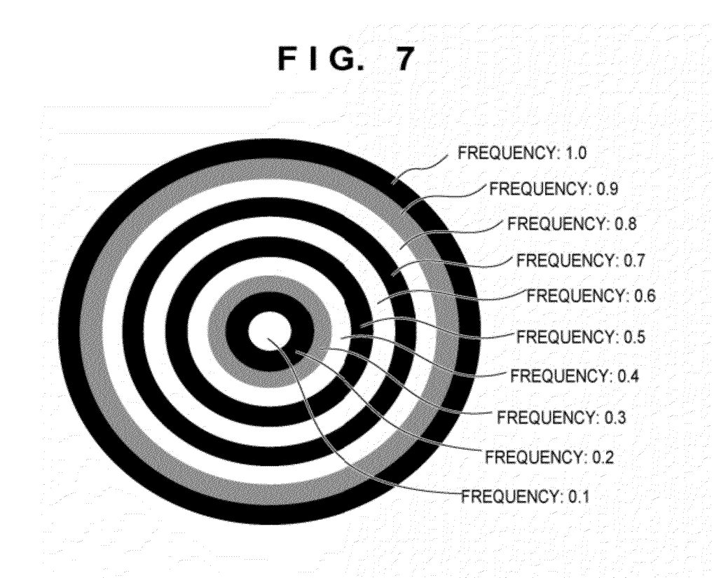

In step S001, the computer sets a variable. The variable is defined as the intensity transmittance distribution of a frequency filter. As shown in FIG. 7, the frequency range normalized assuming that NA=1 is radially divided into 10 frequency zones, and the intensity transmittances in nine frequency zones having radii of 0.2 to 1.0 are adjusted and determined with respect to an intensity transmittance of 1 in the frequency zone in the central zone having radii of 0.0 to 0.1. The variable has nine values in the frequency zones having radii of 0.2 to 1.0 other than the central zone, shown in FIG. 7. In step S002, the computer determines the computation conditions. In this case, the frequency filter uses a pupil filter positioned on the pupil plane of an imaging optical system. The imaging optical system is assumed to have a magnification of 1×, and a numerical aperture NA=0.5. A case in which this imaging optical system is used to obtain signal intensities at the three wavelengths of the R, G, and G components will be considered. The wavelengths of the R, G, and B components are assumed to be 700 nm, 546 nm, and 436 nm, respectively. The signal intensity is determined in correspondence with the contrast of a line pattern having a width of, for example, 2 μm. More specifically, the signal intensity is obtained by subtracting the average of the intensity values at the right and left ends of the central line pattern among five lines which equidistantly align themselves at a pitch of 4 μm from a value 1.33 times the central intensity of the same central line pattern. The signal intensity takes different values for the three wavelengths of R, G, and B components. In this embodiment, the signal intensity is evaluated in the central line pattern, that is, only one portion. In other words, the signal intensity obtained by a sensor has, as a representative value, a value obtained at the position of the sensor center corresponding to the center of the five line patterns.

In step S003, the computer computes nine response values for the nine frequency zones, respectively, in the intensity transmittance distribution serving as a variable. The intensity transmittance in the frequency zone having radii of 0.0 to 0.1 is defined as one, the intensity transmittance of one of the nine frequency zones in the intensity transmittance distribution serving as a variable is defined as a unit amount (for example, one), and the intensity transmittances of the remaining frequency zones are defined as zero. Then, the signal intensity is computed and determined as a response value. In step S004, the computer sets objective functions and evaluation value computation equations. The computer sets objective functions. The objective functions include a function describing the intensities of the R, G, and B components, and a function describing the variance among the intensities of the R, G, and B components. The computer determines an intensity transmittance distribution in which the intensities of all the R, G, and B components are equal to or higher than a predetermined value, and their variance is smaller than a predetermined value. When the signal intensities of all the R, G, and B components are equal to or higher than a predetermined value, signals can be acquired regardless of the differences among the wavelengths of the R, G, and B components. The signal intensities of the R, G, and B components are directly used as a set of evaluation values according to which it is determined whether the signal intensities of all the R, G, and B components are equal to or higher than a predetermined value. The computer determines a pupil filter so that this set of evaluation values is equal to or larger than a predetermined value. A detailed example of the predetermined value is a target value to be set in step S006. When the differences among the signal intensities of the R, G, and B are smaller than the predetermined value, the signal intensities of the R, G, and B components are set to have low wavelength dependence, that is, they are set at a ratio close to 1:1:1. This ratio among the signal intensities can be arbitrarily set as needed instead of 1:1:1. The three signal intensities of the R, G, and B components are used as a set of evaluation values according to which it is determined whether the differences among the signal intensities of the R, G, and B components are smaller than a predetermined value. The computer obtains maximum and minimum signal intensities from these three signal intensities, computes {(Maximum signal Intensity−Minimum Signal Intensity)×100/Maximum Signal Intensity}, and determines the computation result as the evaluation value of the second objective function. The computer determines a frequency filter so that this evaluation value is smaller than a predetermined value. A detailed example of the predetermined value is a target value to be set in step S006.

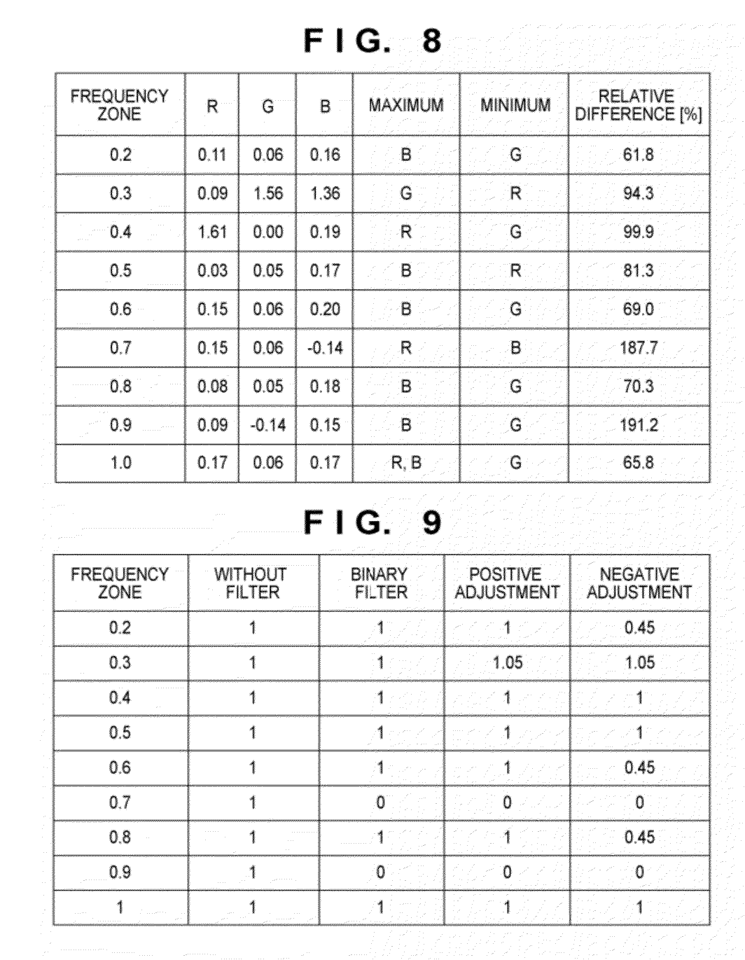

In step S005, the computer computes evaluation values for the objective functions using the response values. FIG. 8 shows the evaluation values. The signal intensities of the R, G, and B components are directly used as a set of evaluation values according to which it is determined whether the signal intensities of all the R, G, and B components are 1.0 or more, and the response values are directly used. A set of evaluation values according to which it is determined whether the differences among the signal intensities of the R, G, and B components are smaller than 10% is represented as a relative difference. In step S006, the computer classifies the sets of evaluation values into N and L types. In this case, referring to FIG. 8, a set of evaluation values including a negative value for the R, G, or B component is defined as the N type, and a set of evaluation values having positive values for all the R, G, and B components is defined as the L type. A set of evaluation values including a negative value is defined as the N type because if a signal corresponding to the contrast has a negative sign, it is impossible to change the sign of the signal to a positive sign by multiplication by a constant as intensity transmittance adjustment. On the other hand, for a set of evaluation values having positive values, the signal intensity can be adjusted by multiplication by a constant, so this set of evaluation values is defined as the L type. Therefore, the threshold for the N-type evaluation value is set to zero. The target values for the L-type evaluation value are defined by the condition in which the signal intensities of all the R, G, and B components are 1.0 or more, and the differences among the signal intensities of the R, G, and B components are smaller than 10%. These target values are used for the evaluation values for the entire pupil filter region, that is, the sum of the evaluation values in all the frequency zones having the adjusted intensity transmittances.

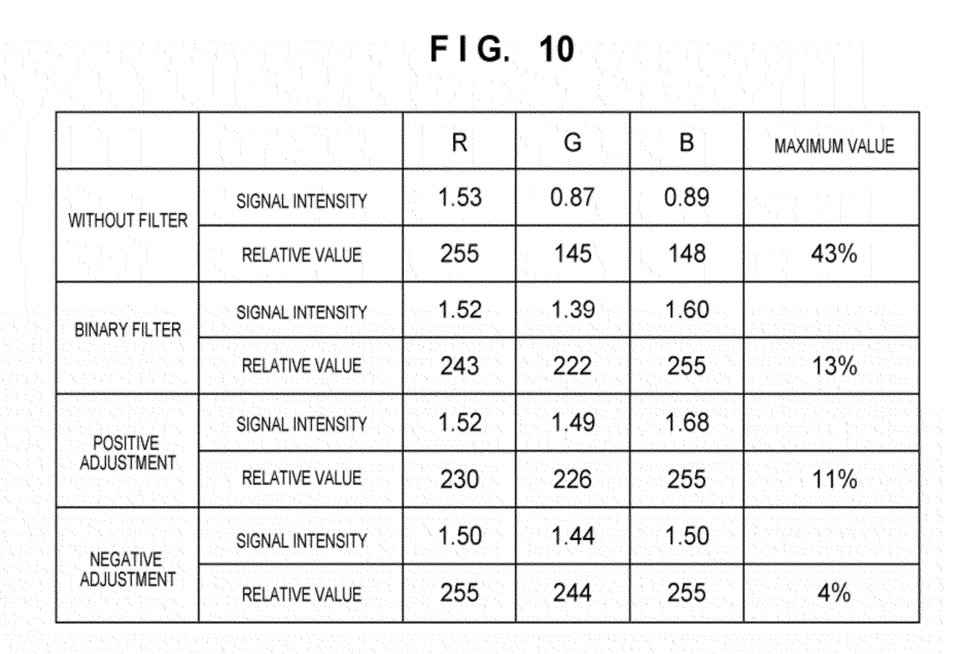

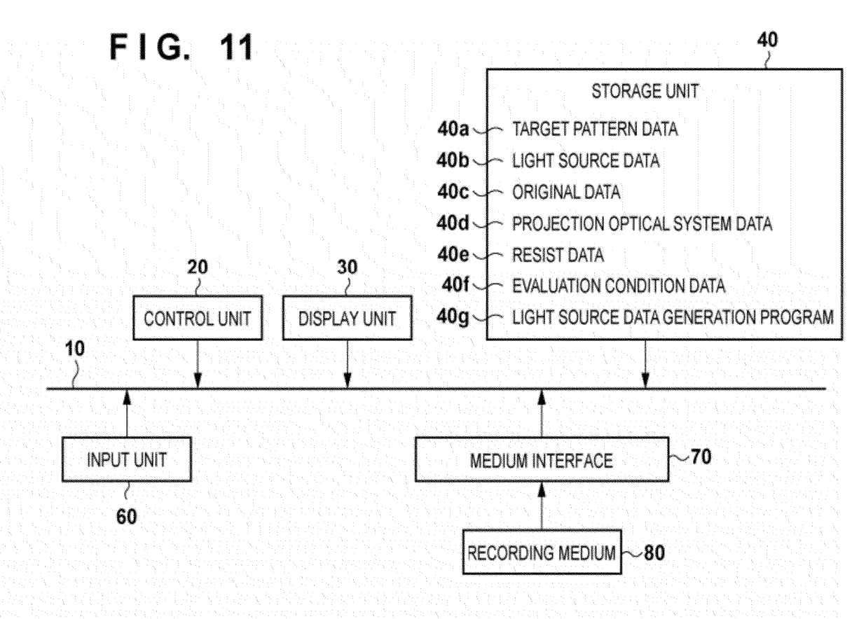

In step S007, the computer determines, as accepted elements, variables having N-type evaluation values equal to or larger than zero threshold. In this embodiment, the set of evaluation values in the frequency zone having a radius of 0.7 includes a negative value for the B component, and that in the frequency zone having a radius of 0.9 includes a negative value for the G component, so these frequency zones are not accepted. The intensity transmittances in the unaccepted frequency zones having radii of 0.7 and 0.9 are set to zero. Seven frequency zones having radii of 0.2, 0.3, 0.4, 0.5, 0.6, 0.8, and 1.0 are determined as accepted elements. The intensity transmittances in the seven frequency zones are defined as one. The intensity transmittance in each frequency zone is shown on the column of “Binary Filter” in FIG. 9. To examine the effect of this adjustment, the signal intensities generated by a pupil filter (binary filter) when the intensity transmittances of the accepted elements are defined as one, and the intensity transmittances of the unaccepted elements are defined as zero, are compared with those generated (without a pupil filter) when the intensity transmittances in all the frequency zones are defined as one. The comparison result is shown on the rows of “Without Filter” and “Binary Filter” in FIG. 10. As the relative value, the signal intensity is represented using 256 gray levels of 0 to 255. Without a filter, the signal intensities of the G and B components are lower than one. The differences among the relative values of the R, G, and B components are 43%. Using a binary filter, the signal intensities of all the R, G and B components become 1.0 or more, so the differences among the relative values of the R, G, and B components reduce to 13%. In the binary filter, the signal intensity of the G component is the lowest. Also, the signal intensity of the R component is the second lowest.

In step S008, the computer adjusts the values of the accepted elements using the L-type evaluation values. In this case, the computer adjusts the values of the seven intensity transmittances in the frequency zones having radii of 0.2, 0.3, 0.4, 0.5, 0.6, 0.8, and 1.0. The computer uses a binary filter as an initial distribution, and increases the intensity transmittance of a positive adjustment element so that the signal intensity of the G component, that is, the lowest signal intensity becomes equal to that of the R component, that is, the second lowest signal intensity, thereby adjusting the intensity transmittance distribution of the pupil filter. The positive adjustment element is selected from the accepted elements. The positive adjustment element is defined as a frequency zone having an evaluation value for the G component, which is larger than those for both the R and B components. The frequency zone having a radius of 0.3 satisfies this condition. When the intensity transmittance in the frequency zone having a radius of 0.3 changes from 1.0 to 1.05, the signal intensities of the G and R components become almost equal to each other. Hence, the computer adjusts the intensity transmittance in the frequency zone having a radius of 0.3 to 1.05. The value “1.05” is determined upon confirming the signal intensity when the intensity transmittance in the frequency zone having a radius of 0.3 is set to 1.05. The intensity transmittances after positive adjustment are shown on the column of “Positive Adjustment” in FIG. 9. The signal intensities after positive adjustment are shown on the row of “Positive Adjustment” in FIG. 10. As can be seen from FIG. 10, the signal intensity of the G component increases, so the differences among the signal intensities of the R, G, and B components reduce. However, a target value of 10% is not reached. In the filter after positive adjustment, the signal intensity of the G component is the lowest. The signal intensity of the R component is the second lowest.

Hence, the computer decreases the intensity transmittance of a negative adjustment element so that the signal intensity of the G component, that is, the lowest signal intensity, becomes equal to that of the R component, that is, the second lowest signal intensity, thereby adjusting the intensity transmittance distribution of the pupil filter. The negative adjustment element is selected from the accepted elements. The negative adjustment element is defined as a frequency zone having an evaluation value for the G component, which is smaller than that for the R or B component, and an evaluation value for the B component, which is larger than that for the R component. The frequency zones having radii of 0.2, 0.6, and 0.8 satisfy this condition. In this case, negative adjustment is performed for the signal intensities of the R component in the frequency zones having radii of 0.2, 0.6, and 0.8. When the intensity transmittances of the signal intensities of the R component in the frequency zones having radii of 0.2, 0.6, and 0.8 are determined as 0.45, the signal intensity of the G component becomes almost equal to that of the R component, that is, the second lowest signal intensity. When the intensity transmittances of the signal intensities of the R component in the frequency zones having radii of 0.2, 0.6, and 0.8 are determined as 0.45, the values of the obtained signal intensities are confirmed. The intensity transmittances after negative adjustment are shown on the column of “Negative Adjustment” in FIG. 9. The signal intensities after negative adjustment are shown on the row of “Negative Adjustment” in FIG. 10. As can be seen from FIG. 10, the signal intensity of the G component increases, so the differences among the signal intensities of the R, G, and B components reduce. The signal intensities of all the R, G, and B components are one or more, and their relative difference is smaller than 10%. Because a target value is reached, the computer determines, as the value of the variable, the intensity transmittance distribution of the pupil filter having undergone negative adjustment. If the target value is not reached even after negative adjustment, the computer performs add adjustment, in which the intensity transmittances in the frequency zones having radii of 0.7 and 0.9 serving as unaccepted elements are adjusted to nonzero values. In this embodiment, the desired performance can be obtained simply by positive adjustment and negative adjustment.

In this embodiment, the constants (1.05 and 0.45) by which the positive and negative adjustment elements are multiplied are determined by confirming the signal intensities obtained when frequency filters corresponding to these constants are used. This confirmation is necessary in this embodiment because the frequency range is radially divided into frequency zones so that the radius of each frequency zone increases in small steps of 0.1. The necessity to confirm the signal intensities can be decreased by radially dividing the frequency range in frequency zones so that the radius of each frequency zone increases in steps smaller than 0.1 as in this embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-008170 filed Jan. 18, 2011, which is hereby incorporated by reference herein in its entirety.

What is claimed is:

1. A recording medium storing a program for causing a computer to execute a method of determining, based on a plurality of objective functions, a light intensity distribution to be formed on a pupil plane of an illumination optical system in an apparatus which forms, on an image plane of a projection optical system, an image of a pattern of an original illuminated with light emitted by the illumination optical system,
the plurality of objective functions including a first objective function represented as a function which has a linear relationship with light intensities in a plurality of regions obtained by dividing the pupil plane, and a second objective function represented as a function which has a nonlinear relationship with the light intensities in the plurality of regions on the pupil plane,
the method comprising:
a first step of calculating, for each region on the pupil plane, the light intensity on the image plane when a value of a light intensity in one region among the plurality of regions on the pupil plane is defined as a unit amount, and the values of light intensities in all the remaining regions are defined as zero;
a second step of calculating, for the each region on the pupil plane, the value of the first objective function and the value of the second objective function using the light intensities on the image plane, which are calculated in the first step;
a third step of setting values of light intensities in a region, in which the value of the second objective function is less than a threshold, to a predetermined value set in advance regardless of an absolute value of the value of the first objective function; and
a fourth step of setting values of light intensities in a region, in which the value of the second objective function is not less than the threshold, in accordance with the value of the first objective function.

2. The medium according to claim 1, wherein the values of the light intensities in the region in which the value of the second objective function is less than the threshold are set to zero.

3. The medium according to claim 1, wherein the fourth step includes increasing a value of a light intensity, which improves at least one of values of the first objective function, that fall below a target value, among the light intensities in the region in which the value of the second objective function is not less than the threshold.

4. The medium according to claim 1, wherein the fourth step includes decreasing a value of a light intensity, which degrades at least one of the values of the first objective function, that fall below a target value, among the light intensities in the region in which the value of the second objective function is not less than the threshold.

5. The medium according to claim 1, further comprising a fifth step of increasing a value of a light intensity, which improves at least one of the values of the first objective function, that fall below a target value, among the light intensities in the region in which the value of the second objective function is less than the threshold, after the fourth step.

6. The medium according to claim 1, wherein
the value of the first objective function is calculated at each of a plurality of positions on the image plane, and
in the fourth step, the values of the light intensities in the region in which the value of the second objective function is not less than the threshold are changed so that the worst value among the values of the first objective function, which are calculated at the plurality of positions, becomes equal to a second worst value.

7. The medium according to claim 1, wherein the objective functions include more than one of a function describing a depth of focus, a function describing a normalized image log-slope, a function describing accuracy of a position of a main pattern which forms the pattern, a function describing uniformity of a size of the main pattern, a function describing accuracy of a shape of the main pattern, and resolution/non-resolution of an auxiliary pattern which forms the pattern, in the image formed on the image plane.

8. The medium according to claim 7, wherein
a value of the function describing the accuracy of the position of the main pattern, and a value of the function describing the uniformity of the size of the main pattern are calculated using an intensity at the center of an optical image of the main pattern, and intensities in a plurality of portions on a peripheral edge of the optical image, and
a value of the function describing the accuracy of the shape of the main pattern is calculated using the intensities in the plurality of portions on the peripheral edge of the optical image.

9. The medium according to claim 7, wherein a value of the function describing the depth of focus is calculated using an optical image formed at a defocus position of the projection optical system.

10. The medium according to claim 7, wherein
the second objective function includes a function describing whether the normalized image log-slope is higher than a threshold, and
the first objective function includes at least one of the function describing the accuracy of the position of the main pattern which forms the pattern, the function describing the uniformity of the size of the main pattern, and the function describing the accuracy of the shape of the main pattern.

11. A recording medium storing a program for causing a computer to execute a method of determining, based on a plurality of objective functions, an intensity transmittance distribution of a frequency filter which adjusts an intensity of a signal used to generate a digital image,
the plurality of objective functions including a first objective function represented as a function which has a linear relationship with light intensities in a plurality of regions obtained by dividing a frequency range of the frequency filter, and a second objective function represented as a function which has a nonlinear relationship with the light intensities in the plurality of regions on the frequency filter,
the first objective function including a function describing intensities of an R component, a G component, and a B component of a signal having passed through the frequency filter, and the second objective function including a function describing a variance among the intensities of the R component, the G component, and the B component, and
the method comprising:
a first step of calculating, for each region on the frequency filter, intensities of an R component, a G component, and a B component of a signal having passed through the frequency filter when the values of intensity transmittances in a central region and one region other than the central region among the plurality of regions obtained by dividing the frequency range of the frequency filter are defined as a unit amount, and the values of intensity transmittances in all the remaining regions are defined as zero;
a second step of calculating, for the each region, the value of the first objective function and the value of the second objective function using the intensities of the R component, the G component, and the B component, which are calculated in the first step;
a third step of setting the values of intensity transmittances in a region, in which the value of the second objective function is less than a threshold, to a predetermined value set in advance regardless of an absolute value of the value of the first objective function; and
a fourth step of setting the values of intensity transmittances in a region, in which the value of the second objective function is not less than the threshold, in accordance with the value of the first objective function.
